(19) United States
(12) Patent Application Publication
(10) Pub. No.: US 2009/0018718 A1
(43) Pub. Date: Jan. 15, 2009

(54) Method of Estimating Life Expectancy of Electric Mining Shovels Based on Cumulative Dipper Loads

(76) Inventors: David M. Lang, South Milwaukee, WI (US); Shyue-Sheng Chang, Muskego, WI (US)

Correspondence Address: QUARLES & BRADY LLP, 411 E. WISCONSIN AVENUE, SUITE 2040, MILWAUKEE, WI, 53202-4497, US

(21) Appl. No.: 12/172,024

(22) Filed: Jul. 11, 2008

Related U.S. Application Data
(60) Provisional application No. 60/949,583, filed on Jul. 13, 2007.

(51) Int. Cl. G06F 19/00

(52) U.S. Cl. 701/29; 701/50; 701/35

(57) ABSTRACT

An operational life of an electric mining shovel is determined by monitoring cumulative dipper loading, both above and below a benchmark weight set by a manufacturer over a time period, such as an operating shift. The running shovel life score is increased when a dipper payload is less than the benchmark weight and increased when the dipper payload is greater than the benchmark weight. The shovel life may be tracked over a time period such as an operator's shift or a thirty day period. The shovel life is used by the operator to operate the shovel in a manner consistent with the manufacturer's ratings.

### CROSS-REFERENCE TO RELATED APPLICATIONS

This application claims the benefit of U.S. Provisional Patent Application Ser. No. 60/949,583, filed on Jul. 13, 2007, and entitled METHOD OF MANAGING SHOVEL LOAD, the entirety of which is hereby incorporated by reference.

### FIELD OF THE INVENTION

This invention relates to heavy equipment for surface mining and loading operations such as electric mining, or ‘rope’, shovels, drag lines, and the like, and more particularly to systems and methods for calculating the cumulative effect of digging and unloading operations on the expected life of the components of such equipment.

### BACKGROUND

In large scale surface mining operations, equipment of immense proportions is used to load and transport material. Loading is often performed by electric mining shovels with a dipper bucket. A typical dipper bucket has a rated load capacity of one hundred tons per scoop. Each load of excavated material is typically deposited into a large capacity truck (for example, having a capacity of 360 tons) and transported to a remote processing location.

Overloading the dipper can lead to premature fatigue and failure causing excessive maintenance costs and decreased shovel efficiency. For example, a shovel operator may bury the dipper into the highwall during digging operations, thereby slowing down production, overloading the dipper, and potentially causing overload damage to machine components. It remains a continuing challenge to prevent such incidents from occurring without adversely affecting machine productivity.

Load measurement systems have been developed and are used to calculate and display the net weight of excavated material in the dipper before it is transferred to the truck. These load measurement systems function by first sensing the electrical load of the power shovel drive motors, then computing the motor torque based on that electrical load, and finally computing an estimate of the net weight based on the motor torque, the known power shovel geometry, and the known tare weights.

This provides a reasonable estimation of the weight of each dipper load and provides real time feedback to the operator. However, without a method for tracking and analyzing the effect of cumulative loading operations such as by estimating the useful life of key components of the shovel, the operator can only guess whether his or her utilization of the shovel is close to that estimated by the manufacturer.

Therefore it would be beneficial to provide a methodology that determines and communicates to the shovel operator, and other appropriate personnel, how successful he or she has been, after the fact, in consistently achieving the rated dipper payload with each excavated load without incurring harmful overloads.

### SUMMARY OF THE INVENTION

One aspect of the present invention provides a method of estimating the operating life of an electric mining shovel by a shovel life score based on the cumulative loading of a dipper. In accordance with the method, each dipper payload weight is determined via an onboard load measurement system. Dipper payloads, both above and below a benchmark value are translated into a relative shovel component life. The magnitude of each dipper load is assessed against the shovel benchmark load rating. A running life score is calculated and indicates the shovel life increase or decrease due to the effect of cumulative dipper loads during operation. This score informs the operator and mine management of their ability to maximize machine capability without incurring damaging overloads. The score may be determined over the course of a single operating shift, a rolling twenty-four hour shift, and the last thirty days.

The foregoing and other objectives and advantages of the invention will appear from the following description. In the description, reference is made to the accompanying drawings which for a part hereof, and in which there is shown by way of illustration a preferred embodiment of the invention. Such embodiment does not necessarily represent the full scope of the invention, however, and reference is made therefore to the claims herein for interpreting the scope of the invention.

### BRIEF DESCRIPTION OF THE DRAWINGS

FIG. 1 is a side elevation view of an electric mining shovel that employs a method of estimating shovel life expectancy in accordance with one aspect of the present invention;

FIG. 2 is a bar graph showing a theoretical benchmark load distribution of a one hundred ton-rated dipper such as used by the electric mining shovel of FIG. 1;

FIG. 3 is a bar graph showing an actual load distribution of a one hundred ton-rated dipper bucket during a selected twenty-four hour period;

FIG. 4 is a graph illustrating three days of actual dipper load data superimposed against the theoretical benchmark load distribution of FIG. 2;

FIG. 5 is a graph illustrating an exemplary running life score of various components of the electric mining shovel of FIG. 1 relative to a baseline life expectancy;

FIG. 6 is a graph illustrating an exemplary running life score of the mining shovel as a whole, superimposed against the individual component life scores of FIG. 5;

FIG. 7 is a graph illustrating an increased running life score of the electric mining shovel of FIG. 1 due to cumulative underloading of the dipper;

FIG. 8 is a graph illustrating the running life score of the electric mining shovel of FIG. 1 using data from three randomly selected days;

FIG. 9 is a graph illustrating a number of running life scores for the electric mining shovel of FIG. 1 with the same loading profile sorted differently;

FIG. 10 is a graph illustrating various running life scores for the electric mining shovel of FIG. 1 for a series of loads all having the same loading average;

FIG. 11 is a graph illustrating various running life scores of the electric mining shovel of FIG. 1 for a series of loads all resulting in an 85% expected life score;

FIG. 12 is a graph illustrating percentages of particular overloads that result in an 85% expected life score; and

FIG. 13 is a graphical illustration of a shovel life score indicator such as may be presented to an operator of the electric mining shovel of FIG. 1.

### DETAILED DESCRIPTION OF THE PREFERRED EMBODIMENTS

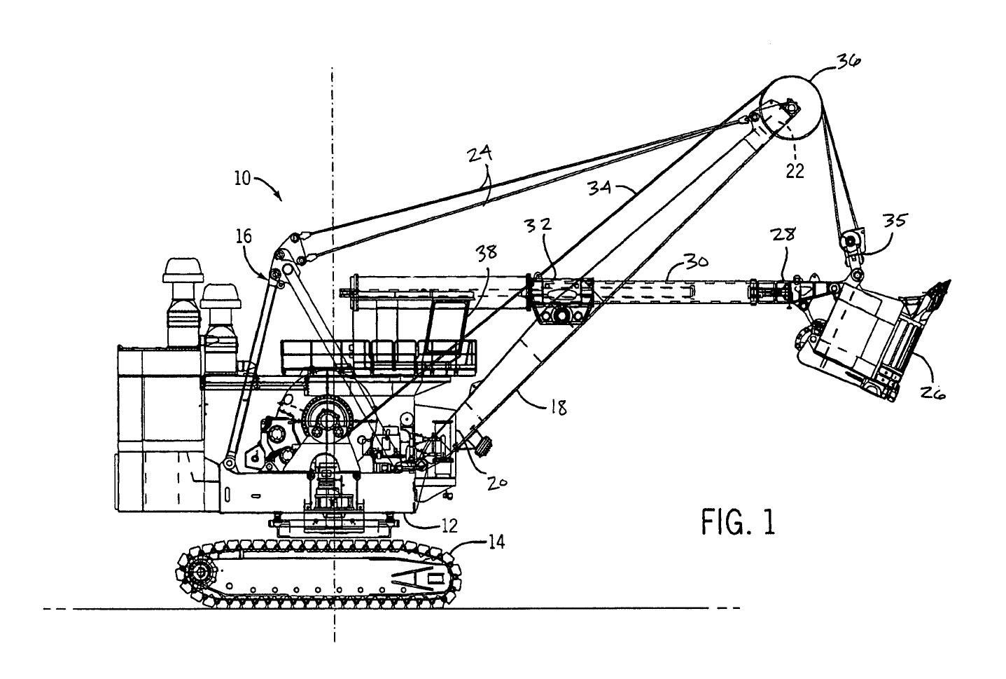

Referring to FIG. 1, an electric mining shovel 10 has a turntable 12 rotatably mounted to a lower frame 14 that includes a set of crawlers. The turntable 12 supports an A-frame structure 16 and a boom 18. The boom 18 includes a lower end 20 pivotally attached to the turntable 12 and an upper, or outer, end 22 connected to the A-frame structure 16 by boom stays 24. A dipper 26 is mounted on the front end 28 of a dipper handle 30 which is slidably supported in a saddle block 32 mounted to the boom 18. The dipper 26 is further supported by a hoist rope 34 which extends from a padlock 35 attached to the dipper 26 and over a boom point sheave 36 mounted at the upper end 22 of the boom 18. The hoist rope 34 is connected to a hoist motor (not shown) to provide for the vertical raising and lowering movement of the dipper 26.

During normal operation, the dipper 26 is crowded outward into a soil bank, hoisted upward to dig and fill the dipper 26, swung to one side, and emptied into a haul truck. These motions and actions are controlled by an electrical control system that operates the various mining shovel components in response to inputs from the operator as well as from control elements, such as limit switches, pressure switches, sensors, and the like. The operator provides the inputs from within a cab 38 with manually operable devices including a joystick, a lever, foot pedals, rocker switches, a computer keyboard, touch pads, and the like.

The control system monitors dipper 26 payloads through the use of an onboard load weight system. An exemplary load weight system, AccuLoad™, determines the weight of each dipper 26 load before it is dumped into a waiting haul truck. In this system, the electrical load of the shovel hoist motor is sensed while the dipper 26 is held above the truck. A hoist motor torque is computed based on the hoist motor electrical load. The net weight of the dipper 26 load is estimated based on the motor torque, the known mining shovel geometry and the known tare weights with appropriate corrections made. Alternatively, other methods of determining the weight of each dipper load may be employed.

The control system is accessible via a remote monitoring system, such as AccessDirect™. Raw dipper load data is transmitted to the remote monitoring system and logged by a reporting software application, such as MIDAS™. The cumulative dipper payload data is then processed and analyzed in view of histograms of previous actual dipper loads and component breakdown frequencies to estimate the running life score of the electric mining shovel 10. The cumulative weight data may be displayed in a meaningful manner in the form of reports, tabulations, or spreadsheets. AccuLoad, AccessDirect, and MIDAS are trademarks of Bucyrus, Inc.

The running life score informs the operator and mine management of their success in maximizing shovel capability without incurring damaging overloads. For example, a 100% score value indicates that the shovel 10 is being operated in a manner consistent with the rating set by the manufacturer. A score above 100% means that the life of the components (and thus the shovel 10) should be better than the norm. This scores may also mean that the shovel 10 may not be working to its full potential. Productivity maximization may be indicated by scores under 100%, at the sacrifice of lower than desired component life. Digging performance envelope containment on shovels can be set at any level. In one embodiment, an 85% life containment limit in any rolling 30 day period is recommended. The running life score score indicates the average increase or decrease due to cumulative dipper loads amassed during a given time period such as a single operating shift, a twenty-four hour period, and the previous thirty day operating period.

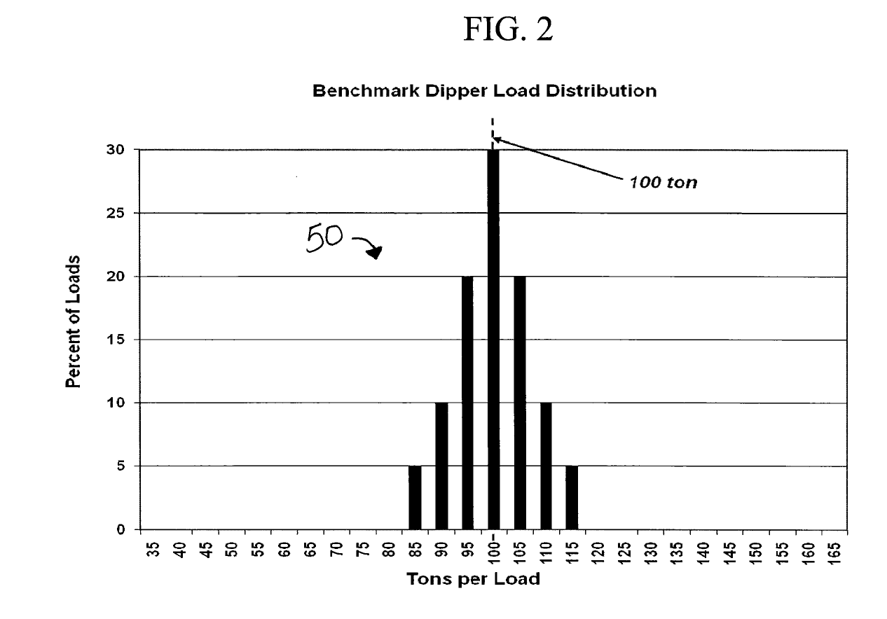

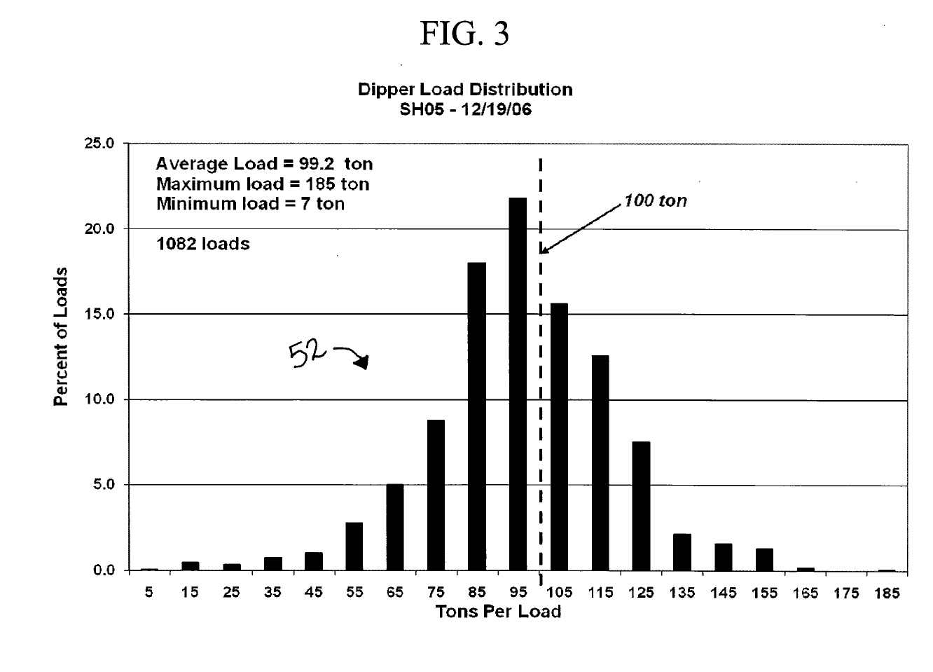

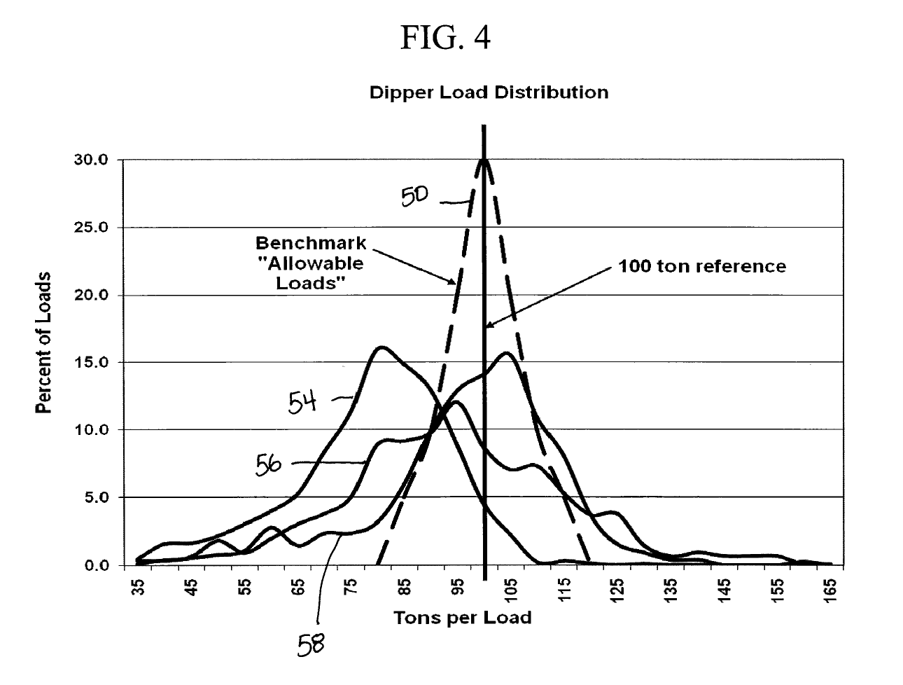

Referring now to FIG. 2, a theoretical benchmark load distribution 50 of a one hundred ton-rated dipper 26 is shown. FIG. 3 shows an actual load distribution 52 of a one hundred ton-rated dipper 26 during a given twenty-four hour period. FIG. 4 shows three days of actual dipper load data 54, 56, 58 superimposed against the theoretical benchmark load distribution 50. As seen in FIGS. 2-4, constraining dipper payloads within the theoretical benchmark 50 is not an easy task.

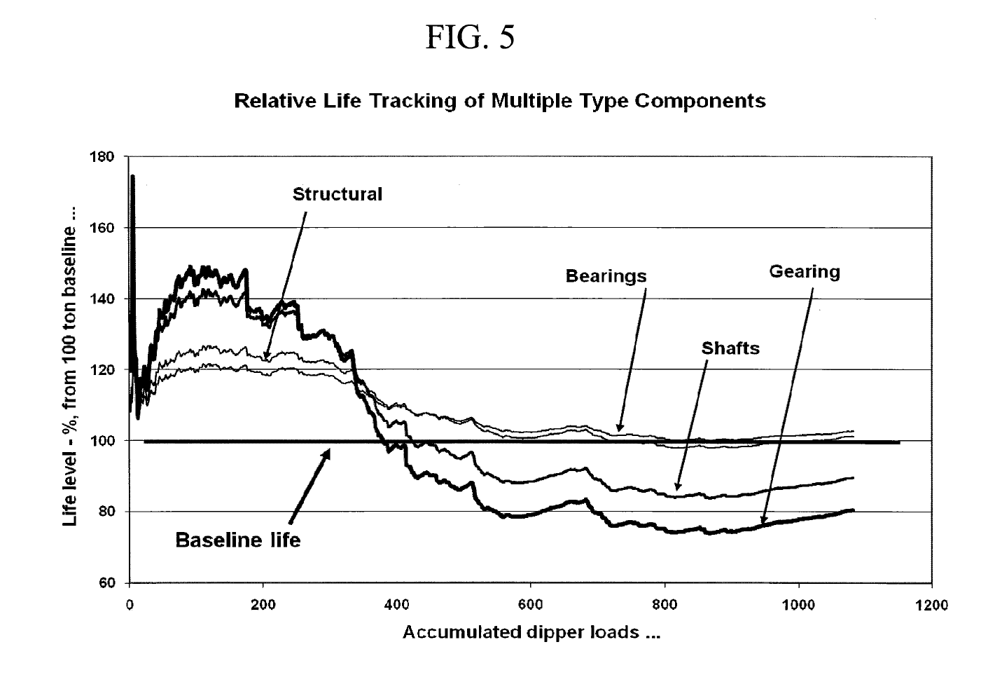

Although not represented in FIGS. 2-4, the actual weight of each dipper 26 payload is a combination of the dipper live load weight (the excavated material), dipper dead weight (the dipper itself), and the weights of dipper liners, the padlock 35, and the forward end 28 of the dipper handle 30. The loading ratio of actual-to-rated weight used to calculate the shovel life scores shown in FIGS. 5-8 and 10-12 includes the sum of all those elements.

For example, it may be incorrectly determined that an actual dipper payload of 125 tons, when compared to the benchmark, or rated, payload of one hundred tons, results in a calculated overload factor of:

125/100=1.25

However, in the exemplary mining shovel 10, the dipper 26, padlock 35, and handle end 28 together weigh 112.6 tons. The actual overload factor is therefore:

(112.6+125)/(112.6+100)=1.12

As described above, the magnitude of dipper loading, either above or below a benchmark level, influences component life. From an accumulation of dipper 26 payload weights, a resultant component life score can be mathematically determined.

Other load/life correlations assume that the dipper percent fill plus dead weight is directly proportional to the torque effort required to fill the dipper and that those torque efforts affect all motions and structures equally. However, this is an oversimplification. More probable percent-fill/life correlations suggested are as follows:

Drives

| | | |
|---|---|---|
| Hoist | 75% | affected |
| Swing | 0% | affected |
| Crowd | 25% | affected |
| Propel | 0% | affected |

Structures

| | | |
|---|---|---|
| Crawler frames | 25% | affected |
| Truck frame | 75% | affected |
| Revolving frame | 75% | affected |
| A-Frame | 75% | affected |
| Boom | 75% | affected |
| Handle | 100% | affected |

Productivity

| | | |
|---|---|---|
| Swing cycle time | 25% | affected |
| Hoist cycle time | 25% | affected |

Therefore, component loading, compared to the benchmark, reflects relative life as a function of the loading ratio raised to an appropriate exponential power. The exponential powers vary from:
3.3 on bearings,
4.2 on structures,
7.5 on shafts; and
9.2 on gearing contact.

FIG. 5 illustrates the running life expectancy, or running life score, of the above-referenced components of the shovel 10 during a selected shift of digging. Life scores for each of the listed components are calculated by applying the respective exponents to the calculated overload factor. The extreme reaction of the life score of the gearing to dipper overloads and underloads is readily apparent.

However, the use of this methodology as an effective tool is compromised if the complexity is too great. The four different life exponents each applied in various manners on different components can become too confusing for effective use. Therefore, a “representative” exponential life factor of 6.7 was selected to be the weighted tool to be applied to all components (and thus representative of the shovel 10 as a whole), for the most practical life indicator. Alternatively, other representative exponential factors may be chosen.

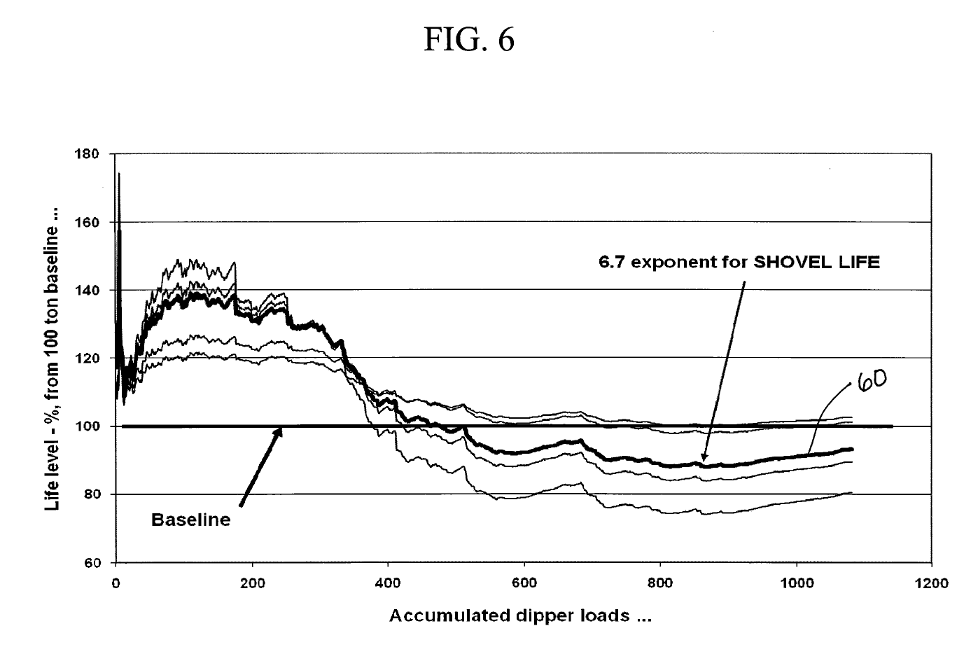

In FIG. 6, the running shovel life score 60, as calculated with the representative “6.7” exponential factor, is shown along with the individual component life scores of FIG. 5. This figure includes data from a single operating day that had some degree of severity in that the shovel 10 life score finished below 100%. Production goals may have been met, but at the cost of reduced expected component life.

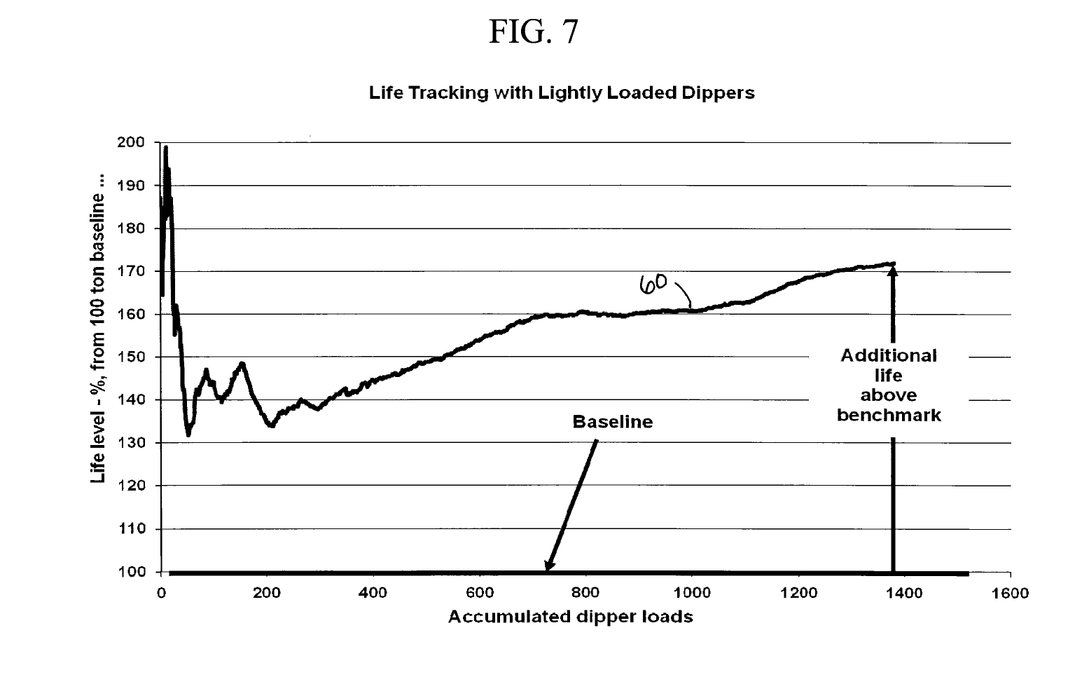

Conversely, FIG. 7 illustrates an operating day with lower payload loading, for example, due to a shallow highwall, resulting in a series of payloads that do not meet production goals but do have a softer effect on shovel life. As shown, the shovel life score 60 at the end of the day finished significantly above the benchmark value of 100.

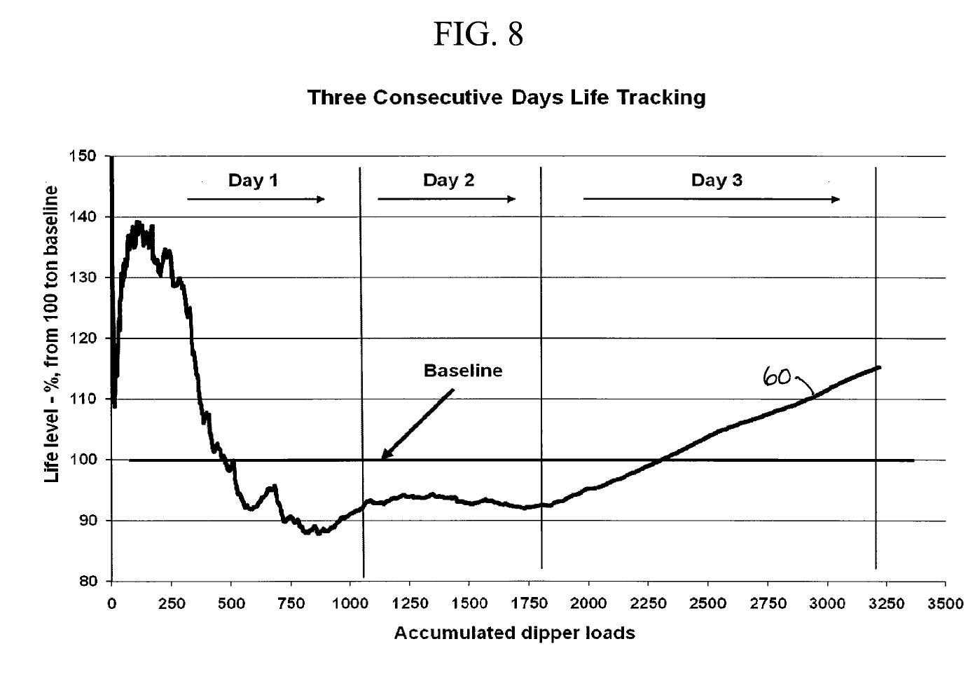

FIG. 8 illustrates data from three random days of shovel operation and the running shovel life score 60. If the payload data or order of days were presented in a random order, the running shovel life score 60 at the end of the three days would be the same value. However, the shape of the running life score 60 would look entirely different with the exception being the same end result score.

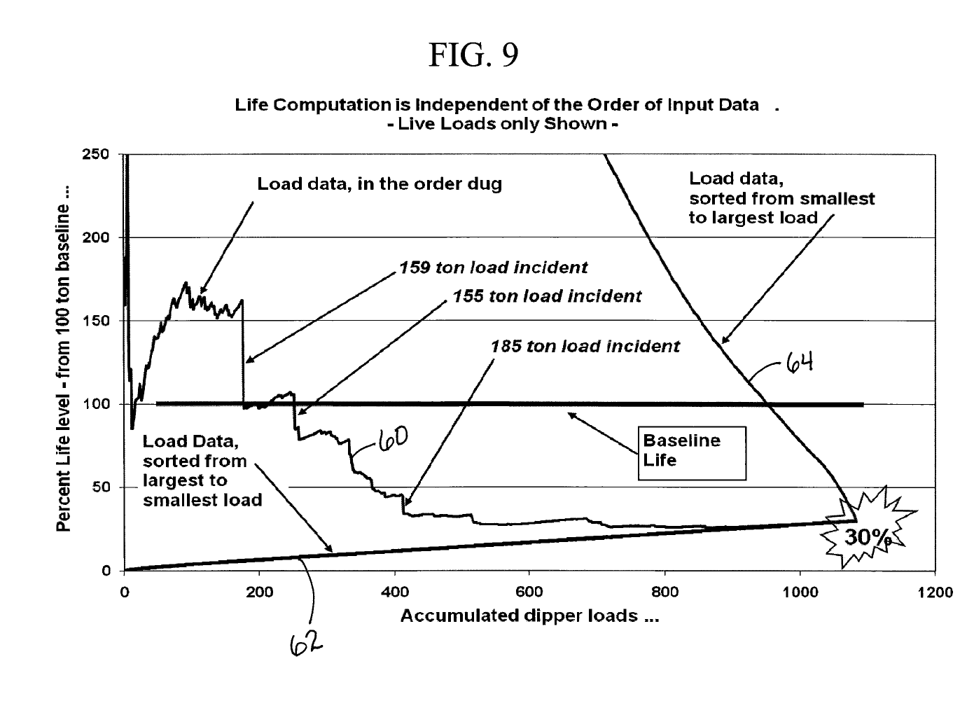

FIG. 9 illustrates that the life score of a shovel 10 at the end of an exemplary operating day is independent of the sequence of the individual dipper loads. An exemplary running shovel life score 60 is displayed in the order in which a series of dipper loads, including a number of significant overloads, were incurred. The same underlying data was then sorted in two ways. Running shovel life score 62 has dipper load data sorted from largest to smallest dipper load while running shovel life score 64 has load data sorted from smallest to largest dipper load. As illustrated, regardless of the sequence of dipper loads, all of the shovel life scores at the end of the operating shift were the same. As an aside, the weight data in FIG. 9 was obtained from live dipper loads in order to exaggerate the visual effect, hence explaining the severity of the shovel life degradation. A more realistic combination of dead loads and live loads would show less shovel life degradation.

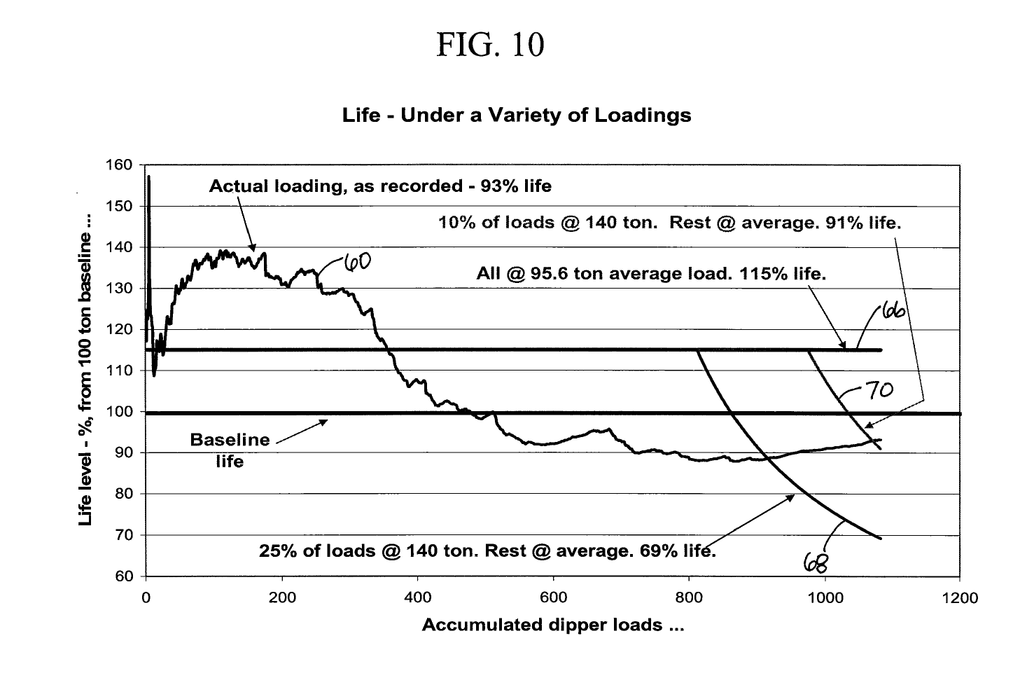

FIG. 10 illustrates a series of shovel life scores, each depicting different running life scores resulting from a variety of loadings. For example, running life score 60 represents actual dipper loadings, the cumulative effect of which over an operating day resulted in a 93% shovel life. In this example, the average dipper load weight of the shovel life score 60 is 95.6 tons. If, over the course of an operating day, all dipper payloads were 95.6 tons, the life score would be 115% and have a flat running life score (66). Running shovel life score 68 represents a scenario where, over the course of an operating day, the first 75% of loads were 95.6 tons each and the remaining 25% of loads were 140 tons each. This results in a 69% shovel life. Running shovel life score 70 represents a scenario where the first 90% of loads were 95.6 tons each and the remaining 10% were 140 tons each, resulting in a 91% shovel life. As shown, a relatively small percentage of overloads can have significant adverse effects on shovel life.

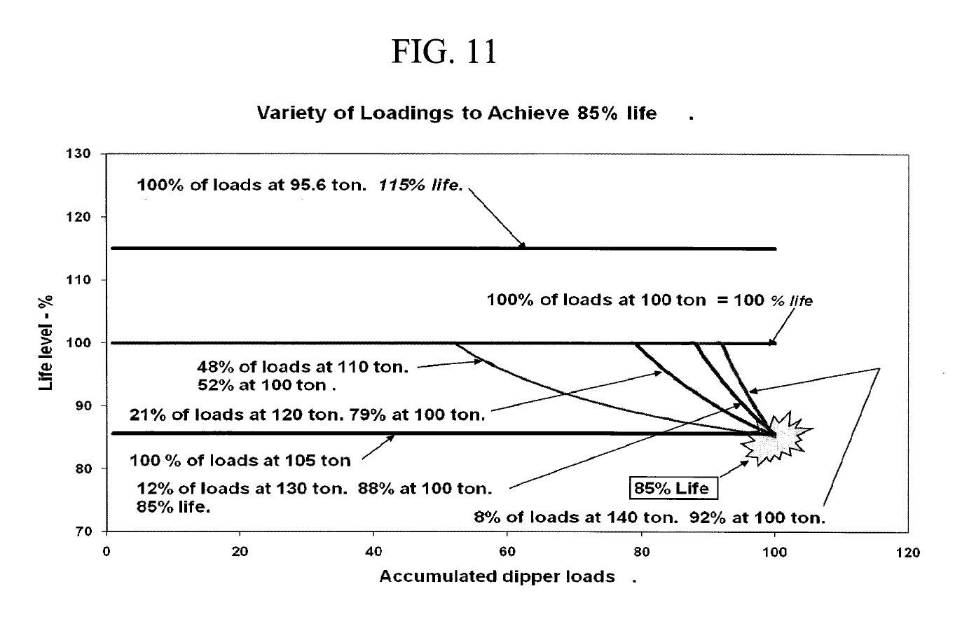

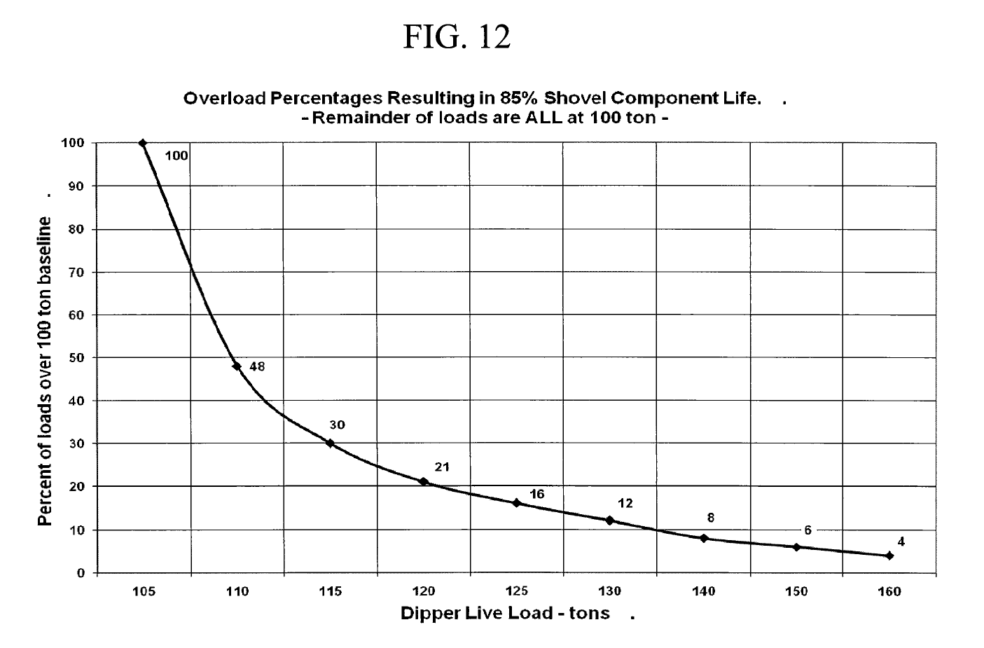

FIG. 11 illustrates a variety of running shovel life scores, each having a series of loads, such that the cumulative effect of each series of loads is an 85% shovel life. FIG. 12 includes the percentages of certain overloads that, along with benchmark loads result in 85% shovel life.

The aforementioned shovel life methodology is intended as a guide to determining useful component life based on dipper loads, overloads, and underloads. Other factors, such as operator abuse, swinging with the dipper in the bank, dipper impacts, fragmentation, highwall cave-ins, and digging on a slope may affect the life of the shovel components, are contemplated but not included in this methodology

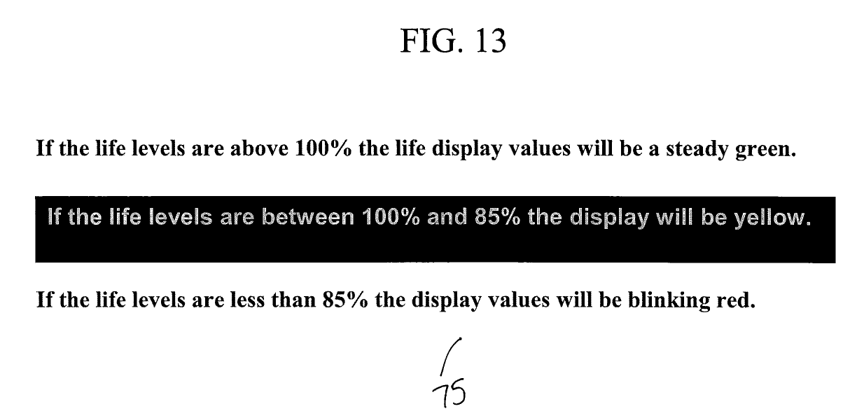

FIG. 13 is an exemplary indicator display 75 of the shovel life score. By communicating the cumulative life of the mining shovel via the display 75, the operator may be able to modify the shovel operation to ensure the life of the shovel is not compromised because of overloads. Further, a report of the specific operator's performance relative to how the operator's performance affects the cumulative life score of the mining shovel can be reviewed periodically to determine whether the operator requires additional training.

The cumulative life scores of specific components of the mining shovel 10 can also be used to determine maintenance requirements as a result of an operator's performance. For example, as discussed above, the life of bearings are affected differently than the life of gearing for the same load. The relative life scores of specific components can be determined as a function of the dipper payloads to determine if a specific component's life is being consumed at a faster rate than anticipated as a result of higher than expected loads being lifted by the mining shovel. A report generated by the mining shovel operating system can be generated to display the need to perform unscheduled maintenance on the specific component aging faster than anticipated to avoid premature failure of the specific component.

Thus, the aforementioned method is of benefit to the health and well being of the shovel 10 as well as associated haul trucks. Utilization of this invention can yield positive results in the form of extended reliability, improved availability, increased productivity, and reduced operating costs. Both machinery end users and suppliers may jointly benefit from this capability.

While there has been shown and described what are at present considered the preferred embodiments of the invention, it will be obvious to those skilled in the art that various changes and modifications can be made therein without departing from the scope of the invention defined by the appended claims.

1. A method of operating a mining shovel, said method comprising:
measuring each load of a plurality of dipper payloads of the mining shovel over a time period;
determining a cumulative life score of said mining shovel over said time period; said cumulative life score being determined as a function of said plurality of dipper payloads; and
communicating said cumulative life score to a user.

2. The method of claim 1, wherein the cumulative life score is communicated to said user via a display.

3. The method of claim 1, furthering comprising:
modifying at least one subsequent dipper payload in response to said cumulative life score.

4. The method of claim 1, wherein the cumulative life score of said mining shovel is displayed at one of: the operator controls for said mining shovel and at a remote terminal.

5. The method of claim 1, wherein said cumulative life score of said mining shovel is determined as a function of the number of said plurality of dipper payloads.

6. The method of claim 1, wherein said cumulative life score of said mining shovel is determined as a function of the weight of said plurality of dipper payloads.

7. The method of claim 6, wherein dipper payloads having a weight greater than a benchmark cause the cumulative life score to be decreased and dipper payloads having a weight less than the benchmark cause the cumulative life score to be increased.

8. The method of claim 7, wherein an amount of change in the cumulative life score is at least partially determined by historical data.

9. The method of claim 8, wherein the historical data is a histogram of the frequency of mining shovel breakdowns.

10. A method of determining a maintenance requirement for a mining shovel, said method comprising:
measuring each load of a plurality of dipper payloads of the mining shovel;
determining a cumulative relative life score of a specific component of the mining shovel as a function of said plurality of dipper payloads; and
reporting a need to perform maintenance of said specific component when said relative life reaches a predetermined threshold.

11. The method as in claim 9, in which said cumulative running life score of said specific component is determined as a function of the weight of said plurality of dipper payloads.

12. A method of determining an estimated mining shovel life based on the loading characteristics of a dipper, the method comprising:
maintaining a life score of the shovel, wherein the life score is cumulative over a period of time and based on the weight of each of a plurality of dipper loads relative to a benchmark;
determining weights of each of a plurality of subsequent dipper payloads;
increasing the running life score for each of the plurality of payloads having a weight less than the benchmark and decreasing the running life score for each of the plurality of payloads having a weight greater than the benchmark.

13. The method of claim 11, wherein the weights of each of a plurality of subsequent dipper payloads are determined over a time period.

14. The method of claim 12, wherein the time period is one of: a single operating shift, a twenty-four hour period, and a thirty day period.

15. The method of claim 11, wherein the amount of the increase and decrease in said running life score is at least partially determined using previous dipper load data including a frequency of component breakdowns.

16. The method of claim 11, wherein each of the plurality of dipper payload weights is determined with an onboard load measurement system.

17. The method of claim 11, further comprising:
transmitting each of the plurality of dipper payload weights to a remote computer;
maintaining the running life score on the remote computer;
increasing the running life score if the payload weight is less than the benchmark and decreasing the running life score if the payload weight is greater than the benchmark after each of the plurality of dipper payloads.
